(19) United States
(12) Patent Application Publication
(10) Pub. No.: US 2007/0101828 A1
(43) Pub. Date: May 10, 2007

(54) Method for processing a saw blade

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., Shanghai (CN)

(21) Appl. No.: 11/545,730

(22) Filed: Oct. 10, 2006

(30) Foreign Application Priority Data
Oct. 10, 2005 (CN) 200510030344.8

(51) Int. Cl. B23D 63/00

(52) U.S. Cl. 76/112

(57) ABSTRACT

A method for producing a saw blade from one piece of material which will result in increased cutting efficiency of the saw blade, a simpler process for producing the saw blade and material reduction is provided. The method includes using a preset trace and a laser beam to simultaneously cut a piece of saw blade material into two saws; using a preset trace and a laser beam to process the sawtooth shape and the fine tooth structure, in which the sawtooth shape and the fine tooth structure form cutting blades with an oblique surface; and using a drill to punch a fixing hole at the top of the saw. The top of the cutting blades is formed in a curved shape, a rectangular shape, or a triangular shape.

### CROSS REFERENCE TO RELATED APPLICATION

This application claims the benefit under 35 USC § 119 of Chinese Patent Application having Application Serial No. 200510030344.8 filed on Oct. 10, 2005, which is incorporated by reference herein.

### BACKGROUND OF THE INVENTION

1. Field of the Invention

Embodiments of the present invention generally relate to method for processing a saw. More particularly, embodiments of the present invention relate to a method for processing a saw blade which will result in increased cutting efficiency, a simpler process for producing the saw blade and will save material.

2. Description of the Related Art

Saws are popular tools used in daily life. Russian Patent No. 2138564 (Sep. 27, 1999) discloses one process for making a saw blade by placing a saw blade and sawtooth in an electrolyte to a depth not less than ¼ of the height of the sawteeth. A voltage is varied to heat the sawtooth. The saw bow is pressed by a pressing plate to prevent deformation. The saw is then air cooled off to a form martensitic structure.

Russian Patent No. 2106948, (Mar. 20, 1998) another process that includes: preparing a saw blade blank; fixing the saw blade to prevent it from loosening during processing; using a laser beam to process the sawtooth (the accuracy in three directions is 0.1 mm); setting and heat treating the sawtooth. A defocused laser beam is used to apply heat treatment to the sawtooth. First, only the odd-numbered teeth are stamped to process stagger teeth. Then, the saw blade is rotated by 180 to process the even-numbered teeth.

This type of saw has several challenges. Of the many challenges, the cutting blade structure of the sawtooth is poor, and the sawtooth processing is complicated.

There is a need, therefore, for a method for processing a saw blade which will increase cutting efficiency of the saw blade, facilitate simpler processing of the saw blade and save material.

### SUMMARY OF THE INVENTION

In one or more embodiments, a method for processing a saw blade is provided. The method increases the cutting efficiency of the saw blade, facilitates the processing of the saw blade, and can save material.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic illustration of a blank from which the saw blade can be made according to one or more embodiments described.

FIG. 2 depicts an enlarged, schematic illustration of a sawtooth according to one or more embodiments described.

FIG. 3 depicts a cross-sectional view along lines A-A of the sawtooth shown in FIG. 2.

FIG. 4 depicts a schematic illustration of a cutting blade shape according to one or more embodiments described.

FIG. 5 depicts a schematic illustration of another cutting blade shape according to one or more embodiments described.

FIG. 6 depicts a schematic illustration of yet another cutting blade shape according to one or more embodiments described.

FIG. 7 depicts a schematic illustration of still yet another cutting blade shape according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

In one or more embodiments, a method for making a saw blade is provided. A piece of material can be used to process two saws at the same time, and the processing steps are simplified.

In one or more embodiments, a laser beam can be used to simultaneously cut a piece of saw blade material (i.e. “blank”) into two saws. A preset trace can be used to facilitate the cut. In one or more embodiments, a laser beam can be used to process the sawtooth shape and the fine tooth structure. The sawtooth shape and the fine tooth structure form cutting blades with an oblique surface. A preset trace can also be used to facilitate the laser process.

In one or more embodiments, a drill can be used to punch a fixing hole at the top of the saw. In one or more embodiments, the top of the cutting blades can have any shape including a curved, rectangular, or triangular shape.

Accordingly, two products can be formed from one cutting sequence. It is possible to take full advantage of the material. In most instances, 100% of the material can be utilized. The cutting blade, according to one or more embodiments described, can have a sharp part shaped rectangularly and melted by the laser beam which can improve the cutting efficiency. As such, the cutting efficiency of the saw can be increased; the processing is simple; and the material can be saved.

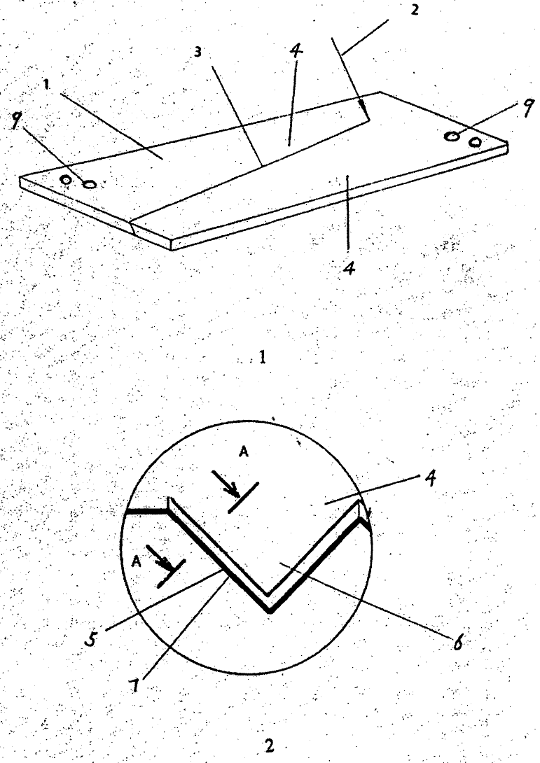

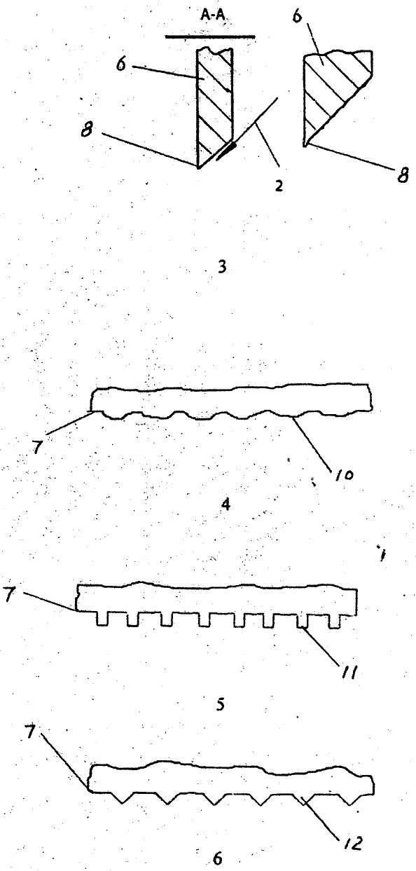

FIG. 1 depicts a schematic illustration of a blank from which the saw blade can be made according to one or more embodiments described. FIG. 2 depicts an enlarged, schematic illustration of a sawtooth according to one or more embodiments described. Referring to FIGS. 1 and 2, a preset trace 3 can be formed on the saw blade material 1 (i.e. “blank”). A laser beam 2 can be used to cut a piece of the saw blade material 1 into two saws 4₁, 4₂. Using a second preset trace 5, a laser beam 2 can be used to process a sawtooth shape 6 and fine tooth structure 7 as shown in FIGS. 2 and 3. As shown in FIG. 1, one or more fixing holes 9 can be made in the saw blade material 1. Any drill or drill bit can be used. The fixing holes 9 help stabilize the material 1 during processing.

FIG. 3 depicts a cross-sectional view along lines A-A of the sawtooth shown in FIG. 2, and FIG. 4 depicts a schematic illustration of a cutting blade shape according to one or more embodiments described. Referring to FIG. 3, the sawtooth shape 6 and fine tooth structure 7 form one or more cutting blades 8 with an oblique surface. The top of said cutting blades 8 is first processed into a curved shape 10 as shown in FIG. 4. The top of said cutting blades 8 can then be processed to any desired shape for cutting.

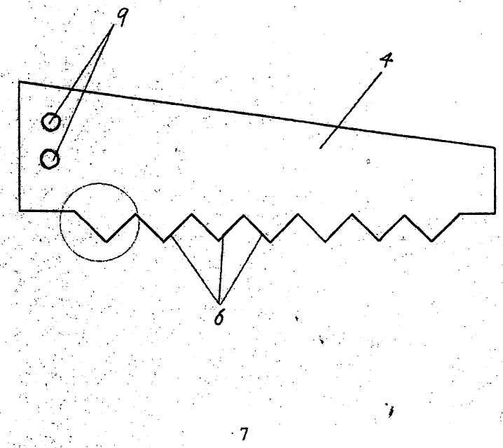

FIG. 5 depicts a schematic illustration of a rectangular shape according to one or more embodiments described, and FIG. 6 depicts a schematic illustration of a triangular shape according to one or more embodiments described. In one or more embodiments above or elsewhere herein, the top of the cutting blades 6 can be processed into a rectangular shape 11 as shown in FIG. 5. In one or more embodiments above or elsewhere herein, the top of the cutting blades 6 can be processed into a triangular shape 12 as shown in FIG. 6.

FIG. 7 depicts a schematic illustration of a finished blade shape according to one or more embodiments described. Although the cutting blades 6 are depicted in a triangular shape as shown in FIG. 6, the cutting blades 6 can having any shape conducive to cutting a desired material including the rectangular shape depicted in FIG. 5.

In another embodiment, the present invention relates to:

1. A process for producing a saw blade, comprising: using a preset trace and a laser beam to cut a piece of saw blade material into two saw blades; using a second preset trace and a laser beam to process a sawtooth shape and a fine tooth structure wherein the sawtooth shape and the fine tooth structure form cutting blades with an oblique surface; and using a drill to punch a fixing hole at the top of the saw blade.

2. The process of paragraph 1, wherein the top of the cutting blade is a curved shape.

3. The process of paragraphs 1 or 2, wherein the top of the cutting blade is a rectangular shape.

4. The process of any of paragraphs 1 to 3, wherein the top of the cutting blade is a triangular shape.

In yet another embodiment, the present invention relates to:

1. A type of saw processing method, characterized by the fact that one piece of material can be used to process two saws at the same time, and the processing steps are as follows: in the first step, according to a preset trace (3), a laser beam (2) is used to cut a piece of saw blade material (1) into two saws (4); in the second step, according to a preset trace (5), a laser beam (2) is used to process sawtooth shape (6) and fine tooth structure (7); sawtooth shape (6) and fine tooth structure (7) form cutting blades (8) with oblique surface; in the third step, a drill is used to punch a fixing hole (9) at the top of saw (4).

2. The process of paragraph 1, wherein the top of cutting blades (6) is processed into a curved shape (10).

3. The process of paragraphs 1 or 2, wherein the top of cutting blades (6) is processed into rectangular shape (11).

4. The process of any of paragraphs 1 to 3, wherein the top of cutting blades (6) is processed into triangular shape (12).

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for producing a saw blade, comprising:
using a preset trace and a laser beam to cut a piece of saw blade material into two saw blades;
using a second preset trace and a laser beam to process a sawtooth shape and a fine tooth structure wherein the sawtooth shape and the fine tooth structure form cutting blades with an oblique surface; and
using a drill to punch a fixing hole at the top of the saw blade.

2. The process of claim 1 wherein the top of the cutting blade is a curved shape.

3. The process of claim 1 wherein the top of the cutting blade is a rectangular shape.

4. The process of claim 1 wherein the top of the cutting blade is a triangular shape.
